(19) United States
(12) Patent Application Publication
(10) Pub. No.: US 2014/0279634 A1
(43) Pub. Date: Sep. 18, 2014

(54) WEB-BASED EMPLOYER-EMPLOYEE NETWORKING SYSTEM

(71) Applicant: Martha Seeker, Chelmsford, MA (US)

(72) Inventor: Martha Seeker, Chelmsford, MA (US)

(21) Appl. No.: 13/838,292

(22) Filed: Mar. 15, 2013

(51) Int. Cl. G06Q 10/10; G06Q 50/00

(52) U.S. Cl. CPC G06Q 10/1053; G06Q 50/01
USPC 705/321

(57) ABSTRACT

A computer-based networking method and system connects individuals and businesses within a trade to match work assignments with availability for work assignments and relevant qualifications. Both employers and individuals job seekers/employees set up and manage their own individual profiles which provide information to others in the network. Members of the network who share a common trade are placed into trade pools. The job seekers within a given trade pools are placed into an employment pool for that trade, and employers are placed into sub-trade pools. The employment pool is graphically associated with the sub-trade pools. Employers view job seeker profiles and availability and can offer work assignments to job seekers in the employment pool. Network members who have worked together can post reviews which can be viewed by others in the network.

### BACKGROUND

In today's society where information is always readily available through computers, tablets, and smart phones, it is easier than ever to connect with people through social networking. Social networking sites make it easy for friends and professionals to stay in touch and for each individual to know what others are doing on a daily basis. When someone gets married, has a child, or gets a divorce, hundreds of their friends and colleagues know instantly. Similarly, in a professional network, when someone takes a new job, their professional colleagues find out immediately through their professional network. Although internet sites exist for employers to advertise jobs and for job seekers to post their resumes, there is a disconnect between them. Job seekers have to actively search for a lengthy period of time to find a job and employers similarly have to search for the employee they are looking for. Often, once this individual or business is found, it is realized that they are simply too far away to make a working relationship feasible, or some other incompatibility factor is realized.

There is a need for employers and job seekers to communicate more effectively and to match up their needs. Unfortunately, because businesses look at other businesses in their industry as competition, communication between them is rare and cooperation is difficult. More and more businesses are hiring through temporary employment agencies, as they find this less risky than hiring new full time employees. Jobless or underemployed individuals spend countless hours going from business to business, either physically, by phone, or by contacting the businesses' web sites, turning in resumes and hoping for a call back. Overwhelmed business owners have trouble finding the time to look through large numbers of resumes and to make numerous phone calls to references. There is an obvious disconnect in businesses and how they relate to others in their field. There is also a disconnect between the unemployed and employers.

### SUMMARY OF THE INVENTION

The invention provides a computer-based networking method and system that connects individuals and businesses within a trade so that they can match work assignments with availability for work assignments and relevant qualifications. Both businesses (employers) and individuals (job seekers/employees) set up and manage their own individual profiles which provide information to others in the network. Only personal identifying information that is approved by the individual is entered and shared with others in the network. Once the profiles are added to a trade-appropriate network, the members of that trade-appropriate network are able to see profile information of all others within that network. The job seekers within a given trade network are placed into an employment pool for the trade, which is visible as a graphic display by all employer members of that same trade network. The employment pool can be represented, for example, as a circle containing graphical representations (avatars) of individual job seekers in the trade network. Employer members of the trade network are grouped into sub-trades according to the services or products they provide, and these sub-trade pools are graphically represented as associated with the employment pool. For example, each sub-trade pool can be represented as a circle at the periphery of the employment pool. The employment pool together with its associated sub-trade pools form a trade pool. After joining the trade network, each employer and each job seeker can individualize their own trade pool by removing individual job seekers and/or employers with whom they do not wish to network.

Within a trade pool, both employers and job seekers are able to network in a variety of ways by sharing different types of information, in addition to work assignment availability. Businesses can share information that will be useful to others in their trade, such as advice on issues related to the field and information on vendors. Both businesses and job seekers are also able to sell and trade tools and equipment using the network. In certain embodiments, employers are able to share employees through the network, businesses can search for subcontractors or job seekers with reviews from others in their trade, and employers can search for temporary or permanent employees within a specified geographical radius. A calendar system is integrated into the search feature of the network. This enables employers to search for those job seekers who are available on specific dates when they are needed. Employers are able to review job seeker profile information, including pictures of the individual and/or their previous work product, reviews from others in the trade pool, resumes, references, compensation per hour, and availability. Once an employer has decided on a particular job seeker, the employer can make a request, e.g., through the calendar system, for the dates they would like that job seeker to work. Job seekers are able to view employee reviews regarding an employer before they accept a job offer. In certain embodiments, reviews of individual job seekers and/or employers can only be submitted by those in the network with whom the individual has worked. Those who are currently out of work, or working less hours that they desire, can use the network to find work on a temporary or permanent basis, even in other areas (i.e., other sub-trades) of their trade pool. Job seekers in the network are constantly visible to employers who could be in need of their services at any given time. A networking site according to the invention will dramatically improve employer-employee interactions in the business world.

Thus, one aspect of the invention is a computer-implemented method for connecting employers with job seekers for work assignments via a networking website. The method includes the steps of: (a) collecting profile information from a plurality of members (employers and job seekers in a common trade) belonging to a network; (b) establishing for each member a graphically represented employment pool containing job seekers, with links to each job seeker's profile information; (c) enabling employers to individualize their employment pool by removing employer-selected job seekers; (d) enabling job seekers to post availability dates and/or times for future work assignments; and (e) enabling an employer to offer a work assignment to a job seeker. In an embodiment, the method further includes the step of (b1) establishing for an employer one or more sub-trade pools, each sub-trade pool containing job seekers and/or service providers practicing a particular sub-trade. In another embodiment, the method includes the step of (f1) enabling an employer who has offered a work assignment to a job seeker to write a review of the job seeker. In another embodiment, the method includes the step of (f2) enabling a job seeker who has accepted a work assignment from an employer to write a review of the employer. In yet another embodiment, the method includes the step of (e1)) enabling an employer to search the calendar information of job seekers for availability on a specified date or over a specified date range. In still another embodiment, the networking members are limited to within a common geographical area. In a variation of this embodiment, geographical information is stored in the profile of each member, and an employer can specify a geographical radius of interest, and the employer's employment pool is populated only with job seekers whose geographical work area or address falls within the specified radius.

Another aspect of the invention is a computer program stored on a computer memory device. The program contains computer code for carrying out the method described above.

Yet another aspect of the invention is a computer network system for carrying out the method described above. The system includes a server and one or more networked devices operated by the network members. The devices can be, for example, a desktop computer, a notebook computer, a tablet computer, or a smart phone.

As used herein, the term “computer network” refers to two or more computers that communicate with one another over fixed communication lines or by wireless communication. A “computer network system” is a computer network that includes a server and one or more remote computer devices communicating with the server and operated by users. A “network” as used herein can refer either to a network of devices, such as computers, communications towers, and cell phones, or to a network of users who interact together in accordance with the invention. A “network member” or “user” as used herein is an individual person who has entered profile information and participates, or intends to participate, in the interactions with other network members as provided by a method of the invention. Generally it Is preferred that users of a computer-implemented method or system of the invention are also members who have entered profile information and participate in periodic or regular exchange of work assignments. However, in certain embodiments the user can be a non-member who is not represented in the system but who, for example, has a one-time work assignment to offer and is granted access to the system, or who has been granted temporary rights to the system on a trial or view-only basis.

Network members include employers and job seekers. An “employer” as used herein refers to an individual person or business who from time to time has, or expects to have, work assignments to offer to job seekers in the network. Generally, the employer compensates the job seeker for performance of a work assignment, although compensation also could be directed elsewhere, such as to the job seeker's primary employer, as agreed between the parties involved. A “job seeker” as used herein refers to an individual person or a business who from time to time seeks work assignments from employers in the network. A job seeker can be, for example, an individual person, a subcontractor, or a company that performs work for another company or an individual person. An “employee” is someone who is regularly employed by an employer. Generally, an employee performs the majority of their work for a single employer (their primary employer), and is paid a salary and benefits by that employer, though the employee may from time to time be available for work assignments from other employers (their secondary employers) in the network. The term “work assignment” as used herein refers to a body of work to be performed for a limited time, generally for a day, a part of a day, or for several days, or for one or more weeks, or for one or more months. In some embodiments the work assignment can be considered permanent, i.e., remaining in place until one or both of the parties decide to terminate it, or until it is terminated by the conditions specified in an agreement. More typically the work assignment relates to a job that is temporary because the work itself is limited in scope, such as limited to one or more projects, or because the employer temporarily has more work than can be accomplished by the employer's regular employees.

The method of the invention is organized around one or more trades. A “trade” as used herein refers to work requiring a common type of labor or skill, or work producing a common type of product, or work using a common type of resource, or work made available to a common type of customer or end user. Some non-limiting examples of trades are construction, animal care, entertainment, food retail, food service and restaurants, agriculture, medicine, dentistry, legal services, finance, building maintenance or cleaning, software development, and the like. Generally, each trade contains two or more sub-trades. A “sub-trade” as used herein is a portion of the trade practiced by workers or businesses having similar skills. Each sub-trade contributes in a unique way to the success or productivity of the trade as a whole. For example, the building construction trade can be said to contain a number of sub-trades, including, as non-limiting examples, carpentry, finish carpentry, masonry, plumbing, electrical work, painting, roofing, cabinetry, heating and air conditioning, and lighting. Each network member identifies himself or herself, or their business, as belonging to one or more trades and/or one or more sub-trades; this information becomes part of their profile.

A computer-implemented method of the invention graphically represents network members and their relationships for the convenience of the user, and to encourage interactions among the members. Members who share certain characteristics are placed together into a pool. A pool is a portion of a database maintained for the purposes of running network and informing its members, but it also refers to the individual persons or businesses within the pool. Pools are typically established at several levels. The highest level is the “trade pool” which contains all the members who have self-identified as being part of a particular trade, including members of sub-trades belonging to that trade, and including both employers who are likely to offer work assignments in that trade and job seekers with skills and availability relevant to that trade. Similarly, a “sub-trade pool” includes the members, both employers and job seekers, who have self-identified as belonging to that sub-trade. A sub-trade pool may also include employees who have been placed into the sub-trade pool as job seekers by their employers. Some sub-trade pools may contain only employer members; these are designated “employer pools”. An employer's own employees can be grouped into an “employee pool”. A pool containing only job seekers is referred to as an “employment pool”.

The interface seen on the viewing screen of a user contains graphical representations of one or more pools of employers and/or job seekers. Particularly relevant to the invention is that relationships between the persons and businesses in different pools are represented visually or graphically in a manner that the user can quickly and intuitively recognize. For example, pools can be represented graphically by using shapes and/or colors on a display screen. Shapes such as circles, ovals, squares, rectangles, triangles, cloud shapes, diamonds, or irregular shapes can be used and can be supplemented with different coloration of the border or use of different fill patterns. The border of each object represents the boundary of the pool, inside of which are contained representations of the individual members (“avatars”). The avatars can be, for example, abstract shapes, photos, caricatures, photographs, drawings, symbols, or text, and they are preferably selected by the user when defining their profile. The full contents of the pool can be displayed within the pool symbol, but if the pool contains a large number of members, a subset of the pool can be displayed, and the subset can be altered by scrolling, swiping, or hovering. The relationships between pools can be represented by a visual grouping of the pools. For example, pools expected to be subject to exchange of members or exchange of work assignments can be placed near or adjacent to one another. A preferred arrangement of pools within a single trade is the “trade flower” in which a central employment pool, typically containing the avatars of job seekers in the trade, is surrounded by one or more sub-trade pools, as petals surround a flower. The relationships between pools can be expressed in a number of ways. For example, the sub-trade pools can touch or partially overlap the employment pool and/or other sub-trade pools, or can be removed from the employment pool but connected to it with lines, channels, tubes, arrows or other shapes. Generally, only one trade will be represented for a given user, but more than one may also be represented, such as when the user has identified as being a member of more than one trade.

Each user is represented by an avatar that is preferably unique among the members of a given trade. A user's avatar can also share common features with other users' avatars, such as a common color or shape for members of a given sub-trade, or different size, shape, or color for job seekers as opposed to employers. While preferred avatars are visual symbols, text, such as the member's name, and also serve as an avatar. Each user enters certain profile information when joining the network, or when editing the user's profile at a later time. Profile information can include information such as (without limitation) name, address, trade, sub-trade, business association, titles, academic degrees, skills, qualifications, names and/or contact information of references, a resume, job history, descriptions or photos of previous work, an identifying photograph or choice of avatar symbol, pay requirements, benefits requirements, date and/or time of availability for work assignments, sub-trade affiliation, and reviews from other members of the network, particularly members with whom the profiled member has previously workded. Profile information of a member can be viewed, for example, by clicking, swiping, or hovering a pointer over the avatar of a member in a pool or by choosing a menu or dialog box selection. In a preferred embodiment, the availability of a job seeker for new work assignments is indicated in a calendar which is part of the job seeker's profile information. In certain embodiments, offers for work assignments by employers are tagged to the job seeker's calendar pending acceptance, or after acceptance by the job seeker.

### BRIEF DESCRIPTION OF THE DRAWINGS

FIG. 1 shows a graphical representation embodiment of a “trade flower” that graphically represents a trade pool, containing a centrally positioned employment pool (20) surrounded by several sub-trade pools (30). The employment pool contains several avatars, each representing a job seeker (40).

FIG. 2 shows another embodiment of a trade flower representation of a trade pool, depicting a centrally positioned employment pool with an associated sub-trade pool (30) and an associated employer pool (35). The employer pool (35) is a type of sub-trade pool in which the avatars each represent a business that provides a type of service common to a sub-trade area. The businesses in the sub-trade pool (35), as employers, can recruit job seekers directly from the employment pool (20) for work assignments. The sub-trade pool shown at upper right (30) is populated with individuals or businesses who may, at different times, either employ workers from the employment pool (20) or place themselves into the employment pool (20) as job seekers, depending on their work load and availability.

FIG. 3 shows a close up of a portion of a trade flower representation of a trade pool in which employers (e.g., contractors) in a first sub-trade pool (35) can offer their employees into a second sub-trade pool (30) as job seekers. The first sub-trade pool contains employers, and the second trade pool contains job seekers performing in a related sub-trade (skilled carpentry). In this embodiment, the employers also can offer work assignments to the job seekers in the second sub-trade pool.

FIG. 4 shows a graphical representation embodiment of a network containing several different trade pools, each with its own associated sub-trade pools. This representation can be used to assist new members in placing themselves into a selected trade pool, or to advertise the contents of the network.

FIGS. 5A and 5B show two examples of trade flower representations of a trade pool. In each case, the trade pool (50) contains a collection of avatars (not shown), each representing a member of the network, grouped into a single, centrally located employment pool (20) and a plurality of associated sub-trade pools (30). Sub-trade pools can be added or removed according to an individual member's preference, for representation on the member's own network devices.

FIG. 6A shows a schematic representation of one embodiment of the display of profile information for an individual trade pool member (e.g., a job seeker). Such information is displayed when the user selects the member's avatar by using a pointer device to click on or hover over the avatar. FIG. 6B shows a schematic representation of one embodiment of a job seeker's calendar. The “X” symbols represent days when the job seeker is not available for work assignments from employers in the trade pool or elsewhere in the network.

FIG. 7 shows a flow chart diagram of an embodiment of a computer program for carrying out a method of operating a trade pool network of the invention on a computer network system.

### DETAILED DESCRIPTION OF THE INVENTION

The invention provides a computer-based networking method and computer network system that greatly facilitate interactions among employers and job seekers in a common trade area. An embodiment of the network is referred to herein as “Stimulus”. A jobseeker using Stimulus can rapidly learn which employer or employers would like to hire them once their availability is entered. An overwhelmed employer using Stimulus can learn immediately whether another employer in the network temporarily has insufficient work for their skilled employees. Employee trading can happen in a matter of minutes. Using Stimulus, employers are less likely to need to contact references, since they will have available real reviews from others in their trade regarding a job seeker's performance or workmanship. Employees using Stimulus will feel a sense of empowerment given their ability to write reviews regarding the way they were treated by an employer. Stimulus can level the playing field for all who participate in the network. A further impact is the fostering of cooperation between individuals or companies who previously were just isolated competitors.

The fundamental organizational unit used in the invention is the trade pool, which is a networked collection of members that includes employers and job seekers. According to the invention, the networked members and their relationships are maintained in a database on a server connected to a computer network, such as the internet or a local area network. A software implementation of a method of the invention represents the trade pool as an image on a display of a device connected to the server via the computer network. FIG. 1 shows one embodiment of a “trade flower” representation 10 of a user's display of their network members and their relationships. An employment pool 20 is represented, preferably at or near the center of the display, by a delimited area containing one or more avatars 40. The employment pool can be represented by any type of filled or unfilled geometric shape. The avatars each represent a job seeker of the trade pool network who from time to time may be available and willing to accept work assignments, or is in immediate need of temporary or permanent employment. The avatars are preferably uniquely identifiable pictures or symbols that the user can readily associate with the person or business represented by the avatar. Each avatar is associated in the underlying database with a variety of profile information of a network member, preferably including an availability calendar, which can be displayed when the user selects or hovers over the avatar with a pointing device.

One or more sub-trade pools 30 are graphically associated with the employment pool, for example by being displayed at its periphery, or by connection with lines or other graphical indicators of a connection between the sub-trade pool and the employment pool. The proximity or connection is symbolic for the capability to exchange members and/or work assignments between the pools. In one embodiment, members who are job seekers are represented as avatars within the employment pool and members who are employers are represented as avatars within one or more sub-trade pools associated with the employment pool. An employer from any of the sub-trade pools can examine the profiles and calendars of job seekers within the job pool and can offer a work assignment to a job seeker selected by the employer. Similarly, a job seeker in the employment pool can examine the profiles of employers in the sub-trade pools and can anticipate what kinds of work assignments might become available; the job seeker might then choose to edit or supplement their profile information.

A sub-trade pool that contains only employers is also called an employer pool. In certain embodiments, such as shown in FIG. 2, the sub-trade pools include a mixture of employer pools 35, containing only employers, and mixed sub-trade pools 30, containing at least one individual or business that at different times or in different situations can be either an employer or a job seeker. The nature of the trade or sub-trade may determine how individuals and companies work together, and thus whether they are apt to exclusively employ workers or might sometimes employ workers and at other times, such as when their work load is low, seek to hire themselves out to others individually or as a group. For example, FIG. 3 shows a situation in which contractors in employer pool 35 can both offer work assignments to skilled carpenters in sub-trade pool 30 (when work is plentiful) and can transfer temporarily unneeded regular employee carpenters (when work is scarce) into the sub-trade pool of carpenters to serve as job seekers. A similar exchange of work and/or employees can operate between employer pool 35 and employment pool 20 (not shown). An employer may also choose to represent some or all of their employees in an employee pool (not shown) that contains only employees of that employer; the employer can then use this employee pool to make selected employees available for work assignments by moving their avatar from the employee pool into either the employment pool or into a sub-trade pool.

The method and system of the present invention are preferably configured for use by members within a single trade, and may also be limited by geographic location. Such limitations confine the scope of membership to those members who are most likely to collaborate. However, the invention also contemplates a larger system containing two or more trades, each represented by a separate trade pool and each containing a separate network of members. FIG. 4 shows such a collection of trade pools, each represented as a trade flower. A single server can provide and control access for as many different trade pools as desired. User displays also can represent a plurality of trade pools, or the displays can represent only a single trade pool. Representations of plural trade pools can be useful for a new user to orient within the overall system and to select one or more trade pools that they would like to network in. Further, in certain embodiments an employer can choose to review job seekers who are outside of their own trade pool, and can use a display such as shown in FIG. 4 to home in on appropriate candidates, and to offer them a work assignment. For example, the employer could navigate across a display of many different trade pools and select one by clicking, typing, or hovering, whereupon a single trade pool display such as in FIG. 1 is produced for the selected trade pool, which can then be navigated as usual.

FIGS. 5A and 5B show examples of two trade pools 50, each represented as a trade flower having a central employment pool 20 surrounded by a number of sub-trade pools 30. The sub-trade pools each focus on an area of the overall trade that utilizes a particular set of skills, technology, or materials, which may or may not overlap among the sub-trade pools. The use of sub-trade pools, preferably each labeled with a characteristic name or symbol, assists the user to navigate within the network, especially for promoting employer-employer interactions such as employee exchange, arrangement of subcontracts, or exchange of information related to the trade.

FIG. 6A depicts an embodiment of member profile information that can be displayed when a member's avatar or name is selected by a user. Member profile information can include the same classes of information for each member or can be individualized. The selection and arrangement of information shown in FIG. 6A is for exemplary purposes only and can be chosen as desired or as appropriate for the trade. Selections in the profile can harbor links to further or more detailed information. For example, selecting “Dates Available” can trigger the display of a calendar such as shown in FIG. 6B. The calendar can contain any type of time-dependent trade-related information desired, such as the schedule for upcoming trade events, but one preferred use of the calendar is to illustrate the availability or non-availability of a member for work assignments. In the example shown in FIG. 6B, the “X” symbols indicate days of non-availability due to regular employment. However, other symbols can be used. Colors also can be used to indicate different conditions of availability. Selection of a calendar date can optionally cause a daily appointment schedule to be displayed, so that assignments can be viewed or added on an hour-by-hour or even a minute-by-minute basis.

FIG. 7 shows a flow chart illustrating one embodiment of a computer-implemented method of the invention. The flow chart represents the flow of information and the relation of steps and program modules in carrying out the method. Software that carries out the various steps of the method, stores and retrieves information to and from one or more databases, creates displays, and accepts user input may be stored and executed on a server and/or on user-controlled devices linked to the server.

### EXAMPLES

### Example 1

### Animal Care Trade Network

An “Animal Care” trade network is established including as members individuals and businesses who work with animals in different ways. Job seekers placed in the employment pool are individuals with experience relevant to work assignments offered by employers in any of the variety of sub-trade pools related to animal care, including those shown in FIG. 5B. Once a person has worked at a boarding facility, they would likely have skills necessary to aid someone in the dog walking sub-trade. Joe owns a dog walking company, and he is overwhelmed with dogs for the next two weeks. Sarah owns a boarding facility, and she hasn't had as much business as she would like lately, and as a result she does not have enough work to keep her employee, Mary, busy. Sarah puts Mary in the employment circle, where Mary is employed by Joe for the next couple of weeks. A Veterinary Clinic has noticed a local outbreak of the canine parvovirus, and the clinic uses the network to notify all local animal caretakers in the network to be on the lookout for symptoms of canine parvovirus. Breeder use the network to answer questions by veterinarians in the network about a particular breed of dog that is bred locally. Animal shelters use the network to work with other sub-trades in the Animal Care trade to see if a new pet adoption candidate they have may be well suited for any of their clients. Pets that go missing are posted on a “wall” in the network for all in the trade pool to view. Veterinarians ask advice from other local veterinarians in their sub-trade pool regarding a difficult diagnosis.

### Example 2

### Construction Trade Network

A “Construction” trade network is formed including as members individuals in various areas of the construction field. Workers who have experience in some aspect of construction are placed as job seekers into the employment pool. Employers in various sub-trades are placed into sub-trade pools associated with the construction employment pool, as shown in FIG. 5A. A general contractor, Ted, has a home owner cancel their remodeling job at the last minute. Ted uses the network to put his two skilled carpenters into the employment pool to look for work assignments. Plumber Chris has just had his crew demolish a tub surround and is surprised to see that the subfloor and surrounding studs are rotten. Chris does not have enough workers available to do all the work necessary to keep his timeline. Chris uses the network to hire Ted's two skilled carpenters for a couple of days to take care of the work. Contractors in different sub-trades post reviews about their experiences with different building inspectors using the network. Tools and box trucks are posted for sale on the network where they are bought and sold between those in the network. Tile installers use the network to share different methods of installing tile.

### Example 3

### Restaurant Trade Network

A “Restaurant” trade network is established with members including local waiters, waitresses, busers, cooks, managers, and restaurant owners. Since most restaurants function similarly, experience gained in one restaurant can be easily transferred to others. A good server in one restaurant knows how to make a dining experience pleasant for those who dine at their place of employment. They memorize orders, communicate to cooks and bar tenders to get the correct orders to their tables and they are sure to check on their table frequently. These are traits that work well in any restaurant. Since there is a high turnover in many restaurants in the network, restaurant owners and managers use the network for ready access to an employment pool of waiters and waitresses.

As used herein, “consisting essentially of” does not exclude materials or steps that do not materially affect the basic and novel characteristics of the claim. Any recitation herein of the term “comprising”, such as in a description of components of a composition, a device, a system, or a method, can be exchanged with “consisting essentially of” or “consisting of”.

While the present invention has been described in conjunction with certain preferred embodiments, one of ordinary skill, after reading the foregoing specification, will be able to effect various changes, substitutions of equivalents, and other alterations to the compositions and methods set forth herein.

What is claimed is:

1. A computer-implemented method for connecting employers with job seekers for work assignments via a networking website, the method comprising the steps of:
(a) collecting profile information from a plurality of members belonging to a network, the members comprising employers having work assignments in a trade and job-seekers seeking work assignments in said trade;
(b) forming a graphical representation for each member of an employment pool comprising job seekers, said graphical representation comprising an avatar for each job seeker of the employment pool, the avatar linked to said job seeker's profile information;
(c) enabling employers of the network to individualize their employment pool by removing selected job seekers from their employment pool;
(d) collecting availability dates and/or times for future work assignments from job seekers and representing a work availability date and/or time collected from a job seeker in a calendar associated with the job seeker's avatar; and
(e) enabling an employer to offer a work assignment to a job seeker in the employer's member pool by associating the offer with the job seeker's calendar.

2. The method of claim 1, further comprising the step of:
(b1) forming a graphical representation of one or more sub-trade pools, each sub-trade pool containing job seekers and/or employers practicing a particular sub-trade, said graphical representation of one or more sub-trade pools being associated with the graphical representation of the employment pool.

3. The method of claim 2, wherein employers of a sub-trade pool are enabled to offer work assignments to job seekers in the employment pool, and/or wherein employers of a sub-trade pool are enabled to place themselves into the employment pool as job seekers.

4. The method of claim 3, wherein an employer makes an employee of the employer available as job seeker to one or more employers in a sub-trade pool.

5. The method of claim 4, wherein an employer's own employees are graphically represented as avatars in an employee pool that is graphically associated with the employer's employment pool.

6. The method of claim 5, wherein the employer makes employees available for work assignments by moving them from the employee pool to a sub-trade pool by a drag and drop action.

7. The method of claim 2, wherein the employer selects the one or more sub-trade pools from a list of available sub-trade pools related to said trade.

8. The method of claim 1, wherein employers access their graphically represented employment pools from one or more access points selected from the group consisting of computer workstations, notebook computers, tablet computers, and smart phones.

9. The method of claim 1, wherein a job seeker's avatar is graphically displayed as an image selected by the job seeker.

10. The method of claim 7, wherein the image is a photograph provided by the job seeker, a facial image of the job seeker, or an icon.

11. The method of claim 1, wherein a job seeker's availability dates and/or times are represented on a graphical image of a calendar or linked to a graphical image of a calendar.

12. The method of claim 1, wherein placing a pointer over a job seeker's avatar displays profile information and/or a calendar of the job seeker.

13. The method of claim 1, further comprising the step of:
(f1) enabling an employer who has offered a work assignment to a job seeker to write a review of the job seeker, the review associated with the job seeker's avatar and accessible by other employers in the network.

14. The method of claim 13, wherein the review is accessible only by employers having said job seeker in their employment pool.

15. The method of claim 1, further comprising the step of:
(f2) enabling a job seeker who has accepted a work assignment from an employer to write a review of the employer, the review accessible by other job seekers in the network.

16. The method of claim 15, wherein the review is accessible only by job seekers in said employer's employment pool.

17. The method of claim 1, further comprising the steps of:
(f1) enabling an employer who has offered a work assignment to a job seeker to write a review of the job seeker, the review associated with the job seeker's avatar and accessible by other employers having said job seeker in their member pool; and
(f2) enabling a job seeker who has accepted a work assignment from an employer to write a review of the employer, the review accessible by other job seekers in the network.

18. The method of claim 17, wherein the employer and the job seeker cannot access each other's reviews until both reviews are completed, and wherein the reviews cannot be edited once completed.

19. The method of claim 1, wherein new members added to the network are automatically assigned to trade pools and/or sub-trade pools based on their profile information.

20. The method of claim 1, wherein new members added to the network self-select one or more trade pools and/or sub-trade pools to which they are added.

21. The method of claim 1, wherein job seeker profile information comprises a resume, one or more photographs, a skill or background description, geographical work area information or address information, a previous job description, an availability calendar, a review by a previous employer, and contact information for one or more references.

22. The method of claim 1, wherein the networking members are within a common geographical area.

23. The method of claim 1, wherein job seekers and/or employers are placed into geographical area-specific employment pools of members within the geographical area.

24. The method of claim 23, wherein an employer can specify a geographical radius of interest, and the employer's employment pool is populated only with job seekers whose geographical work area or address falls within the specified radius.

25. The method of claim 1, wherein job seekers in the network are regularly employed part-time or full-time by employers in the network.

26. The method of claim 1, wherein job seekers in the network are seeking temporary or permanent work assignments.

27. The method of claim 1, further comprising the step of:
(e1) enabling an employer to search calendar information of job seekers in the employer's employment pool for job seekers who are available on a specified date or over a specified date range.

28. The method of claim 1, wherein said trade is construction and said sub-trade is selected from the group consisting of carpentry, finish carpentry, masonry, plumbing, electrical work, painting, roofing, cabinetry, heating and air conditioning, and lighting.

29. A computer program stored on a computer memory device, the program comprising computer code for carrying out the method of claim 1.

30. A computer network system for carrying out the method of claim 1, the system comprising a server and one or more networked devices operated by said employers or said job seekers, the devices selected from the group consisting of a desktop computer, a notebook computer, a tablet computer, and a smart phone.
